(19) United States
(12) Patent Application Publication
(10) Pub. No.: US 2026/0195561 A1
(43) Pub. Date: Jul. 9, 2026

(54) MEMORY OPTIMIZATION IN LOW MEMORY DEVICES FOR ARTIFICIAL INTELLIGENCE (AI) MODEL INFERENCE

(71) Applicant: Honeywell International Inc., Charlotte, NC (US)

(72) Inventor: Ambarish Pathak, Mirzapur (IN)

(21) Appl. No.: 19/010,212

(22) Filed: Jan. 6, 2025

(51) Int. Cl. G06N 3/02; G06T 1/60; G06T 9/00

(52) U.S. Cl. CPC G06N 3/02; G06T 1/60; G06T 9/00

(57) ABSTRACT

Approaches for optimizing memory in low memory devices for Artificial Intelligence (AI) model inference are described. According to one example, a system may obtain a data file comprising an encoded AI model having a plurality of layers. Further, a portion of the encoded AI model is decoded to extract data pertaining to a first layer from the plurality of layers. The extracted data is stored in a memory. Thereafter, a first input is processed through the extracted data pertaining to the first layer to generate a first output. Upon generating the first output, the data pertaining to the first layer may be erased from the memory. Thereafter, another portion of the encoded AI model is decoded to extract data pertaining to a second layer from the plurality of layers till all layers are decoded. The output of a previous layer is provided as an input to a subsequent layer.

### BACKGROUND

Neural networks have become integral to various applications in artificial intelligence, including natural language processing, computer vision, and decision-making systems. These networks consist of interconnected layers of neurons, with each connection represented by a weight that represents the strength of connections between neurons. Large neural models, including deep learning models and transformers, have shown remarkable capabilities in tasks like text processing, image recognition, and complex problem-solving. As the applications of neural networks continue to proliferate, there is an increasing demand to make these sophisticated models more widely accessible. This accessibility is crucial for deployment across a diverse array of devices and computing environments, from powerful data centers to resource-constrained edge devices.

### SUMMARY OF INVENTION

This summary is provided to introduce concepts related to memory optimization in low memory devices for Artificial Intelligence (AI) model inference. This summary is not intended to identify essential features of the claimed subject matter nor is it intended for use in determining or limiting the scope of the claimed subject matter.

In an aspect of the present subject matter, a system for optimizing memory in low memory devices for Artificial Intelligence (AI) model inference is disclosed. The system includes a processor and a machine-readable storage medium comprising instructions executable by the processor. The instructions when executed cause the processor to obtain a data file comprising an encoded artificial intelligence (AI) model. In an example, the AI model includes a plurality of layers. Further, a portion of the encoded AI model may be decoded to extract data pertaining to a first layer from the plurality of layers. In an example, the extracted data is stored in the memory. The instructions when executed further cause the processor to process a first input through the extracted data pertaining to the first layer to generate a first output. Thereafter, another portion of the encoded AI model may be decoded to extract data pertaining to a second layer from the plurality of layers. In an example, the first output is provided as a second input to the second layer to obtain a second output. Upon generating the first output, the data pertaining to the first layer may be erased from the memory for memory optimization.

In an aspect of the present subject matter, a method for optimizing memory in low memory devices for Artificial Intelligence (AI) model inference is disclosed. The method includes sending a request to a server for downloading a deep neural network (DNN) model hosted at the server. In an example, the DNN model comprises a plurality of layers associated with weight matrices. The method further includes obtaining at an edge device one or more images indicative of a compressed form of a plurality of weight matrices associated with the plurality of layers. The one or more images are received from the server in response to the request. Thereafter, the method includes retrieving each weight matrix, one at a time, from the one or more images. Each retrieved weight matrix may be uncached from the edge device after an inference is obtained from the retrieved weight matrix and before retrieving a subsequent weight matrix.

In yet another aspect of the present subject matter, a non-transitory computer readable medium for optimizing memory in low memory devices for Artificial Intelligence (AI) model inference is disclosed. The non-transitory computer readable medium has instructions stored thereon. The instructions, when executed by a processor, cause the processor to perform operations. In the operations, an encoded artificial intelligence (AI) model is obtained from a server. The AI model comprises a plurality of layers pre-encoded into one or more images. In addition, the operations cause to store the one or more images in a non-volatile memory (NVM) of the system. Further, iteratively, for each layer of the plurality of layers in the encoded AI model a portion of the one or more images may be decoded to extract weight data for a layer. The extracted weight data may be loaded into a volatile memory of the system and an input may be processed through the layer using the extracted weight data to generate an output. Once the output is generated, the extracted weight data may be deleted from the volatile memory. Thereafter, the output may be provided as input for a subsequent layer. In an example, decoding the portion of the one or more images comprises converting the portion into numerical weights associated with the layer.

### BRIEF DESCRIPTION OF FIGURES

Systems and/or methods are now described, in accordance with examples of the present subject matter and with reference to the accompanying figures, in which:

FIG. 1 illustrates a system for optimizing memory in low memory devices for Artificial Intelligence (AI) model inference, according to an example;

FIG. 2 illustrates a network environment comprising a memory optimization system for optimizing memory in low memory devices for Artificial Intelligence (AI) model inference, according to an example;

FIG. 3 illustrates a schematic block diagram of an encoding system for encoding an Artificial Intelligence (AI) model for optimizing memory in low memory devices for AI model inference, according to an example;

FIG. 4 illustrates a schematic block diagram of a memory optimization system for optimizing memory in low memory devices for Artificial Intelligence (AI) model inference, according to another example;

FIG. 5 illustrates an exemplary sequence flow diagram depicting memory optimization in low memory devices for Artificial Intelligence (AI) model inference, according to an example;

FIG. 6 illustrates a method for optimizing memory in low memory devices for Artificial Intelligence (AI) model inference, according to an example;

FIG. 7 illustrates a method for encoding an Artificial Intelligence (AI) model for optimizing memory in low memory devices for AI model inference, according to another example;

FIG. 8 illustrates a method for optimizing memory in low memory devices for Artificial Intelligence (AI) model inference, according to another example; and

FIG. 9 illustrates a computing environment implementing a non-transitory computer-readable medium for optimizing memory in low memory devices for Artificial Intelligence (AI) model inference, according to an example.

### DETAILED DESCRIPTION

The widespread adoption of neural networks, particularly large and complex models such as deep learning architectures and transformers, has led to significant advancements in artificial intelligence applications. However, deployment of such neural networks requires substantial memory that may often exceed capabilities of many devices, especially edge devices with limited computational resources. The core issue stems from an architecture of neural networks, which comprise multiple layers of interconnected neurons. Each connection between neurons is represented by a weight, and these weights collectively form large matrices. In deep neural networks, the number and size of the weight matrices may be substantial, leading to AI models that occupy gigabytes of memory.

For instance, a single weight matrix of dimension 1,000,000×1,000,000 may require approximately 8,000,000×800 bytes of storage, which is large for many devices. This memory constraint limits deployment of sophisticated AI models on a wide range of devices, particularly in scenarios where offline processing is necessary or Internet connectivity is unreliable. The issue is further aggravated in applications requiring real-time processing.

To overcome the memory constraint, the deep neural networks may be compressed by using techniques, such as quantization. Quantization of deep neural networks (DNNs) involves reducing the precision of the model weights and activations, typically from 32-bit floating-point to lower bit-width representations. While this technique significantly reduces model size and improves inference speed, quantization poses several challenges to maintaining model accuracy. Reducing numerical precision inherently leads to loss of information, potentially degrading the model's ability to capture fine-grained patterns in data.

To this end, approaches for optimizing memory in low memory devices for deriving inferences from large AI models are described. The present subject matter facilitates compressing large AI models without losing effectiveness of the AI models, thereby enabling the AI models to work on many different types of devices, such as low memory edge devices.

In one example, a large AI model, such as a deep neural network (DNN) model, may be stored or hosted in a server, such as a cloud server. The DNN model may include a plurality of layers and associated weight matrices. A low memory device, such as an edge device, may send a request to the server for obtaining the AI model. In response to the request, the large AI model may get encoded at the server. In an example, the large AI model may be pre-encoded at the server. In an example, the large AI model may be encoded as one or more images representing the plurality of layers and weight matrices associated with the plurality of layers of the large AI model.

Further, the one or more images may be downloaded on the edge device. In an example, the one or more images may be stored in a memory, such as a non-volatile memory, of the edge device. To derive inference from the large AI model, the one or more images may be decoded. In an example, a portion of the one or more images may be decoded to extract a first layer of the plurality of layers and the associated weight matrix. The extracted first layer and the weight matrix may be stored in a volatile memory of the edge device. Thereafter, a first input may be processed through the first layer and the weight matrix associated with the first layer of the large AI model. As a result of the processing, a first output may be generated.

Thereafter, another portion of the one or more images may be decoded to extract a second layer and the associated weight matrix. In an example, the first output may be provided as an input to the second layer to generate a second output. In this manner, each layer of the AI model is extracted one at a time, until a final output or inference is obtained. In addition, once the first output is generated, the first layer and the associated weight matrix are erased from the volatile memory.

Accordingly, by encoding the large AI model as images and decoding only one layer at a time, the memory requirements may be drastically reduced. This allows complex AI models to run on devices with limited memory. In addition, the image-based compression of the large AI model may maintain high fidelity to the original model weights, preserving the AI model's effectiveness. As may be evident from above, the ability to run complex AI models on less powerful hardware may reduce an overall cost of AI deployment in various scenarios.

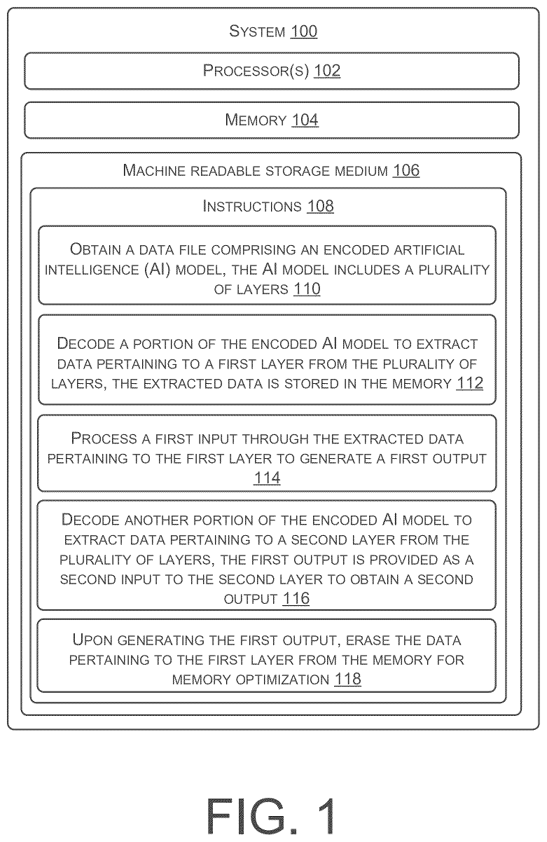

The present subject matter is further described with reference to FIG. 1 to FIG. 9. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for optimizing memory in low memory devices for Artificial Intelligence (AI) model inference, according to an example. As used herein, the term “low memory devices” may refer to computing devices with limited memory resources compared to traditional desktop computers or servers. These devices typically have constrained random access memory (RAM) and/or storage capacity, which may limit their ability to run complex software or process large amounts of data simultaneously. Examples of the low memory devices may include, but are not limited to, smartphones, tablets, Internet of Things (IoT) devices, edge computing devices, and Industrial control systems. In some cases, low memory devices may have RAM capacities ranging from a few hundred kilobytes to a few gigabytes, and storage capacities that may be limited to several gigabytes or less. The specific memory thresholds that define a “low memory device” may vary depending on the context and the requirements of the AI models being deployed.

The system 100 may be a device, such as an edge device, that may be configured to process an AI model to derive inference from the AI model. Examples of the electronic device may include, but are not limited to, a laptop, a desktop, a tablet computer, and a smartphone. The system 100 may be implemented in any suitable hardware, software, firmware, or a combination thereof. In some aspects, the system 100 may be implemented as a system-on-chip (SoC), a field-programmable gate array (FPGA), an application-specific integrated circuit (ASIC), or a microcontroller unit (MCU). The system 100 may also be implemented as a distributed system across multiple devices or nodes in a network, such as in a fog computing or edge computing architecture. In some cases, the system 100 may be integrated into IoT devices, wearable technology, or embedded systems in various industries including automotive, healthcare, and industrial automation. Although not depicted, the system 100 may include other components, such as interfaces to communicate over the network or with external storage or computing devices, display, input/output interfaces, operating systems, applications, data, and other software or hardware components (all of which have not been depicted).

The system 100 may include a processor 102, a memory 104, and a machine-readable storage medium 106 which is coupled to, and accessible by, the processor 102. The processor 102 may be implemented as a dedicated processor, a shared processor, or a plurality of individual processors, some of which may be shared. The processor(s) 102 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labelled as “processor(s)”, may be provided through the use of dedicated hardware as well as hardware capable of executing computer-readable instructions.

The memory 104 may be a computer-readable medium, examples of which include volatile memory (e.g., RAM), and/or non-volatile memory (e.g., Erasable Programmable read-only memory, i.e., EPROM, flash memory, etc.). The memory 104 may be an external memory, or internal memory, such as a flash drive, a compact disk drive, an external hard disk drive, or the like. The memory 104 may further include data which either may be utilized or generated during the operation of the system 100.

The machine-readable storage medium 106 may be communicatively connected to the processor 102. Among other capabilities, the processor 102 may fetch and execute computer-readable instructions, including instructions 108, stored in the machine-readable storage medium 106. The machine-readable storage medium 106 may include non-transitory computer-readable medium including, for example, volatile memory such as RAM (Random Access Memory), or non-volatile memory such as EPROM (Erasable Programmable Read Only Memory), flash memory, and the like. The instructions 108 may be executed to classify the hardware components of the computing device.

In an example, the processor 102 may fetch and execute the instructions 108. In one example, as a result of the execution of the instructions 110, the system 100 may obtain a data file comprising an encoded artificial intelligence (AI) model. In an example, the AI model may include a plurality of layers. The data file may refer to a compressed or encoded representation of a large AI model. Large AI models may refer to artificial intelligence models, particularly neural networks, that have a substantial number of parameters and layers, resulting in significant memory and computational requirements. Large AI models may be characterized by high parameter count, often in the millions or billions, multiple interconnected layers, substantial memory requirements, potentially occupying gigabytes of storage. Examples of the large AI models may include, but are not limited to, a deep neural network (DNN) model, a transformer model, large language models (LLMs), and convolutional neural networks (CNNs) with numerous convolutional layers.

Further, the data file may include one or more images representing the plurality of layers and associated weight matrices of the AI model. These images may be obtained by converting numerical weight data of the AI model into an image-based format. The data file may further include metadata indicating an order for decoding and processing the plurality of layers of the encoded AI model. The data file may store the encoded AI model as a series of image slices. Each image slice may correspond to a portion of a layer of the plurality of layers. In an example, the data file may be structured to allow selective retrieval of portions of the encoded AI model based on the memory capacity of the device processing it.

Upon obtaining the data file, the instructions 112 may be executed to decode a portion of the encoded AI model to extract data pertaining to a first layer from the plurality of layers. The extracted data may be stored in the memory 104 of the system 100. In an example, the decoding process may involve converting the image-based representation for each of the plurality of layers back into a numerical weight data associated with each layer. This conversion may utilize a decompression algorithm specific to the image format used for compression of the weight matrices.

In an example, the decoding process may be performed iteratively, with only one layer being decoded at a time to optimize memory usage. Further, the system 100 may use the metadata included in the data file to determine the correct order for decoding and processing each of the plurality of layers.

The extracted data may include the weight matrix associated with the first layer, as well as any other necessary parameters for that layer, such as bias terms or activation function specifications. This data may be loaded into the volatile memory, such as RAM, of the system 100 for immediate processing.

Once the data is extracted, the instructions 114 may be executed to process a first input through the extracted data pertaining to the first layer to generate a first output. Processing of the first input may involve applying the input data to the weight matrix and other parameters corresponding to the first layer that have been extracted and loaded into the volatile memory of the system 100. The first output may serve as an intermediate representation of the input data, capturing features or transformations relevant to the AI model's task. The first output may be temporarily stored in the volatile memory for use in subsequent layer processing.

To this end, the instructions 116 may be executed such that another portion of the encoded AI model is decoded to extract data pertaining to a second layer from the plurality of layers. The first output is provided as a second input to the second layer to obtain a second output. In an example, the processor 102 may, based on the metadata associated with the data file, convert the relevant image data into numerical weights associated with the second layer. Such conversion may utilize similar decompression algorithms as used for the first layer, such as JPEG decompression, PNG decompression, or other suitable methods depending on the image format used. Thereafter, the first output may be processed through the second layer using the newly extracted weight data. The resulting second output may represent a further transformation of the input data, capturing higher-level features or representations relevant to the AI model's task.

Additionally, the instructions 118 may be executed to erase the data pertaining to the first layer from the memory, upon generation of the first output, to optimize memory utilization in the system 100. In an example, after the first output is generated and passed to the second layer for processing, the data, such as weight matrix and any other parameters, associated with the first layer may be removed from the memory 104. Accordingly, when the data pertaining to the second layer is loaded into the memory 104 of the system 100, such data replaces the now-processed data pertaining to the first layer. This sequential loading and unloading of layer data allows the system 100 to efficiently manage memory usage.

Accordingly, the present subject matter allows the system 100 to scale to very large AI models by processing the AI model layer-by-layer and erasing data to manage memory usage dynamically. In addition, the memory optimization technique as described herein may enable deployment of sophisticated AI models on edge devices with limited computational resources, expanding the potential applications and use cases for AI technology.

The above functionalities performed as a result of the execution of the instructions 108 may be performed by different programmable entities. Such programmable entities may be implemented through any computing systems, which may be implemented either on a single computing device, or multiple computing devices. As will be explained, various examples of the present subject matter are described in the context of a computing system which encodes the large AI model into image format and facilitates decoding the image format in a layer by layer manner to optimize memory utilization. These and other examples are further described with respect to the remaining figures.

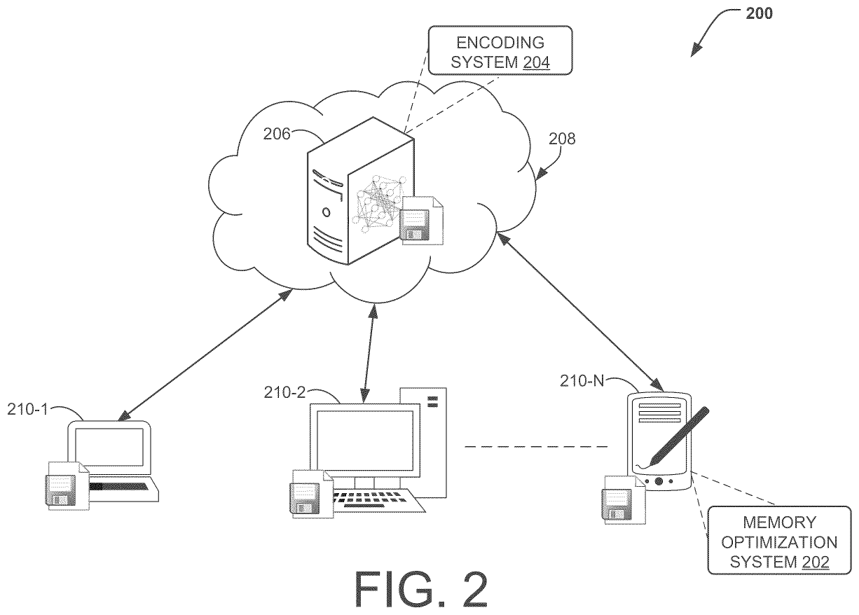

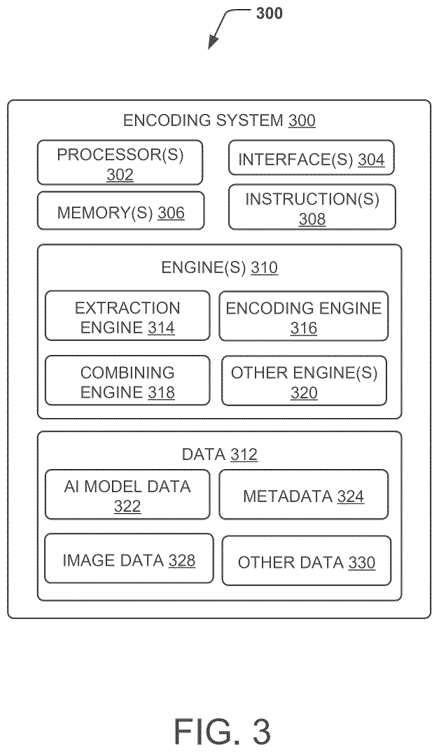

FIG. 2 illustrates a network environment 200 comprising a memory optimization system 202 for optimizing memory in low memory devices for Artificial Intelligence (AI) model inference, according to an example. The network environment 200 may include, without limitation, an encoding system 204 implemented in a cloud server 206. The encoding system 204 may be designed to encode large AI models, such as deep neural network (DNN) models or transformer models, into compressed files. This encoding process may significantly reduce the memory footprint of the large AI models, making large AI models more suitable for deployment on devices with limited computational resources. In an example, the encoding system 204 may encode the plurality of layers and associated weight matrices of the large AI model into one or more images where each image corresponds to a layer of the large AI model. In another example, each layer may be encoded into multiple slices of one image by the encoding system 204. The encoding system 204 is further explained in conjunction with FIG. 3.

The cloud server 206 may be part of a network 208, which may provide distributed computing resources and storage capabilities. The network 208 may be a wireless network, a wired network, or a combination thereof. The network 208 can also be an individual network or a collection of many such individual networks, interconnected with each other and functioning as a single large network, e.g., the Internet or an intranet. The network 208 can be implemented as one of the different types of networks, such as intranet, local area network (LAN), wide area network (WAN), the internet, and such. The network 208 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other.

Further, the cloud server 206 may be communicably coupled to a plurality of user devices 210-1, 210-2, . . . , 210-N, collectively referred to as user devices 210 and individually referred to as the user device 210. Each user device 210 may include the memory optimization system 202 for enabling decoding of a large AI model in a sequential manner. Examples of the user devices 210 may include, but are not limited to, a laptop, a desktop, a tablet, a notebook, and so on. In an example, certain embodiments of the network environment 200 may include additional or alternative elements and components, as desired for the particular application.

The memory optimization system 202 may be similar to the system 100 and may operate to decode portions of the encoded file, derive inference from each decoded portion, erase the decoded portion from which inference has been derived, and decode a subsequent portion of the encoded file. The memory optimization system 202 may be implemented by any computing device that includes at least one processor, a memory, a user interface, and a communication hardware. In the present example, the memory optimization system 202 may be configured to decode each layer from the plurality of layers of the large AI model and delete the layer from which inference has been derived. In other example, the memory optimization system 202 may be implemented using a system integrated with the user devices 210, which is configured to decode each layer from the plurality of layers of the large AI model and delete the layer from which inference has been derived.

The encoded AI model may be stored on the cloud server 206 and made available for download to the user devices 210. When a user device 210 requests the AI model, the compressed version may be transmitted over the network 208, reducing data transfer requirements and enabling faster deployment. Upon receiving the encoded AI model, the memory optimization system 202 on the user device 210 may employ a sequential decoding and processing approach. This approach may involve decoding only a portion of the encoded file at a time, typically corresponding to a single layer of the AI model. The memory optimization system 202 may then process input data through this decoded layer, generate an output, and subsequently erase the decoded data from a memory (not shown) of the user device 210 before proceeding to the next layer.

This sequential processing may allow the user device 210 to effectively run large AI models that would otherwise exceed available memory capacity of the user device 210 if the large AI models are loaded in entirety. By decoding and processing one layer at a time, the memory optimization system 202 may maintain a small memory footprint throughout the inference process.

FIG. 3 illustrates a schematic block diagram of an encoding system 300 for encoding an Artificial Intelligence (AI) model for optimizing memory in low memory devices for AI model inference, according to an example. The encoding system 300 includes processor(s) 302 similar to the processor(s) 102. Further, the system 300 includes interface(s) 304 and memory(s) 306. The interface(s) 304 may allow the connection or coupling of the system 300 with one or more other devices, through a wired (e.g., Local Area Network, i.e., LAN) connection or through a wireless connection (e.g., Bluetooth®, Wi-Fi). The interface(s) 304 may also enable intercommunication between different logical as well as hardware components of the system 300. The memory 306 may be similar to the memory 104.

The encoding system 300 may further include instructions 308, engine(s) 310, and data 312. In an example, the instructions 308 are fetched from the memory 306 and executed by the processor 302 included within the encoding system 300. The engine(s) 310 includes an extraction engine 314, an encoding engine 316, a combining engine 318, and other engine(s) 320. The other engine(s) 320 may further implement functionalities that supplement functions performed by the encoding system 300 or any of the engine(s) 310. The data 312, on the other hand, includes data that is either stored or generated as a result of functions implemented by any of the engine(s) 310 or the encoding system 300. It may be further noted that information stored and available in the data 312 may be utilized by the engine(s) 310 for performing various functions by the encoding system 300. In an example, the data 312 may include AI model data 322, metadata 324, image data 326, and other data 330.

The AI model data 322 may represent parameters and structures of DNN models, transformer models, or any other type of machine learning model that requires encoding for efficient deployment. The AI model data 322 may include weight matrices, layer configurations, activation functions, and other essential components that define the AI model's architecture and parameters. The metadata 324 may include details about architecture of the AI model, layer ordering, number of layers, and so on. It may be noted that such examples are only indicative. The present approaches may be applicable to other examples without deviating from the scope of the present subject matter.

In operation, the extraction engine 314 may parse the AI model to identify structure of the AI model and obtain information pertaining to the AI model, including the number and types of layers, connections between layers, and associated parameters. Based on the parsing, the extraction engine 314 may extract information pertaining to the number of layers in the AI model, types of layers, connections between different layers, and so on. The information pertaining to the AI model is then stored by the extraction engine 314 as the AI model data 322.

Further, the extraction engine 314 may extract weight matrices and bias vectors from each layer of the AI model. A weight matrix is a two-dimensional array of numerical values that represent the strength of connections between neurons in adjacent layers of an AI model. Each element in the weight matrix corresponds to the weight of a connection between two specific neurons. In a fully connected layer, the weight matrix W has dimensions (m×n), where m is the number of neurons in the current layer and n is the number of neurons in the previous layer. Each row in the matrix corresponds to a neuron in the current layer, and each column corresponds to a neuron in the previous layer. Further, a bias vector is a one-dimensional array of numerical values, with one bias term for each neuron in a layer. The extraction engine 314 may store the weight matrices and the bias vectors as the metadata 324.

Once the weight matrices are extracted, the extraction engine 314 may convert the weight matrices into numerical values corresponding to these matrices and the bias vectors. The extracted data is organized in a format that maintains the relationship between weights, biases, and their corresponding layers.

Further, the encoding engine 316 may convert the numerical values corresponding to the weight matrices into visual representations, such as images. In one example, the encoding engine 316 may encode the AI model in various ways. For instance, the entire AI model may be encoded as one image. Alternatively, the encoding engine 316 may encode each weight matrix corresponding to a layer of the AI model into one image. In some aspects, the encoding engine 316 may divide each weight matrix into k matrices and may encode each of the k matrices as image slices. The encoding approach may be selected based on factors such as the size of the AI model, the number of layers, the dimensions of the weight matrices, or the desired compression ratio.

In an example, the encoding engine 316 may employ Python Imaging Library (PIL) for converting numerical arrays of the weight matrices into image format. Accordingly, the encoding engine 316 may transform the large weight matrices of the AI model into compact image representations. Specifically, the encoding engine 316 may receive a weight matrix as an input. The encoding engine 316 may reshape the weight matrix into a 2D array suitable for image representation. Thereafter, the encoding engine 316 may employ the PIL to convert the 2D array into an image format, such as PNG or JPEG.

In another example, the encoding engine 316 may use techniques like matrix reshaping and color channel mapping. For example, a 2D weight matrix may be reshaped into a square or rectangular image, with each weight value mapped to a pixel intensity. In some cases, different color channels (e.g., RGB) may be used to represent multiple weight matrices or different aspects of the neural network structure. In another example, the encoding engine 316 may use frequency-domain transformations, such as Discrete Cosine Transform (DCT) or wavelet transforms, to represent weight matrices more compactly. This approach may allow for more efficient compression and enable progressive decoding of the model.

The above-described encoding techniques allows for substantial compression of the AI model weights. For example, a weight matrix of 1,000,000 elements that originally required 8,000,000 bytes may be compressed to one or more images requiring only 48 bytes, achieving a remarkable reduction in storage requirements.

In addition, the encoding engine 316 may apply compression algorithms to reduce the size of the converted data, which may include lossless or lossy compression techniques depending on the requirements. Lossless compression techniques, such as Huffman coding, may be used to preserve exact weight values of the weight matrix.

The encoding engine 316 may further generate encoding metadata, including information about the encoding scheme used for each component. The encoding metadata may specify the image format, compression algorithm, decoding instructions having sequence of layers, color channel mapping, and any quantization parameters used and so on. The encoding engine 316 may store the encoding metadata as the metadata 324.

In an example, the encoding engine 316 may employ mixed-precision techniques, using higher precision for critical layers and lower precision for less sensitive parts of the network. For instance, the first and last layers of a network may use 16-bit quantization, while hidden layers use 8-bit quantization. Mixed-precision encoding allows for optimizing the trade-off between model accuracy and computational/memory efficiency.

Once the encoding has been performed, the encoding engine 316 may perform certain validation checks to ensure whether the encoded data can be accurately decoded and can be used for inference. For example, to validate the encoded data, the encoding engine 316 may calculate a mean squared error (MSE) or other similarity metrics between the original and reconstructed weight matrices. For example, if the MSE is below a predetermined threshold (e.g., 1e−6), the encoding may be considered valid.

In some examples, the encoding engine 316 may conduct layer-wise validation. In the layer-wise validation, each layer of the encoded AI model may be individually decoded and compared to its original counterpart. This approach may help identify specific layers where encoding errors or information loss may have occurred.

In an example, the encoding engine 316 may validate the metadata associated with the encoded AI model. This may involve checking that all necessary information for decoding and using the model is present and correctly formatted. For example, it may verify that layer types, activation functions, and tensor shapes are accurately recorded in the metadata.

Once the metadata 324 is collated and the AI model is encoded as one or more images, the combining engine 318 may generate a data file by combining the one or more images and the metadata. In some aspects, the combining engine 318 may create a container file that encapsulates both the encoded images and the metadata 324. The container file format may include headers or sections that clearly delineate the image data from the metadata 324.

In an example, the combining engine 318 may assemble the encoded components (weight matrices, activation functions, etc.) into a coherent structure that preserves the original model architecture. For example, the combining engine 318 may create directories or nested data structures that represent the layers of the AI model, with each directory containing the relevant encoded images and layer-specific metadata.

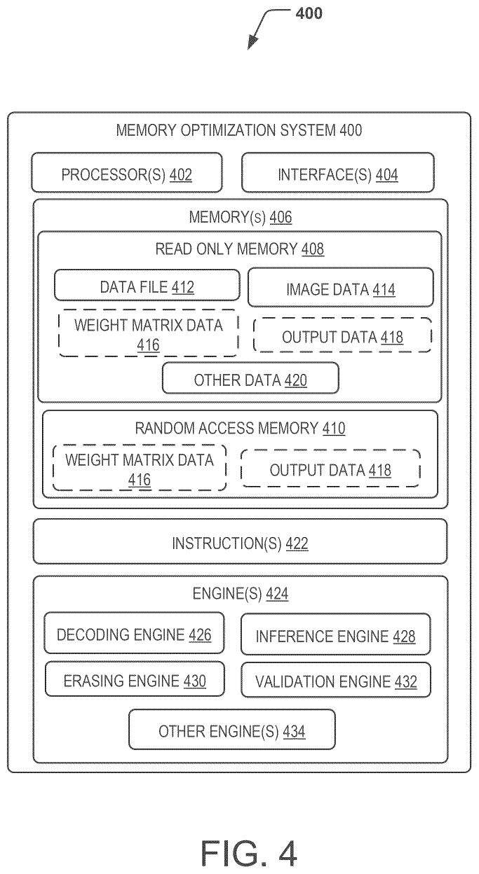

The combining engine 318 may also incorporate error detection or correction codes into the data file to ensure the integrity of the encoded AI model during transmission or storage. The error detection codes may include checksums for individual components or redundancy measures for critical metadata. In some aspects, the combining engine 318 may generate multiple versions of the data file such that each version may be optimized for different target devices or use cases. For example, the combining engine 318 may create a version with higher compression for devices with very limited storage, and another version with faster decoding capabilities for devices that prioritize inference speed. The data file so generated by the combining engine 318 may be transmitted to one or more user devices, such as the user devices 210 for being decoded in an efficient manner for optimizing memory of the user device. The manner in which the memory optimization is performed for deriving inference from the AI model is further described in conjunction with FIG. 4.

FIG. 4 illustrates a schematic block diagram of a memory optimization system 400 (hereinafter referred to as optimization system 400) for optimizing memory in low memory devices for Artificial Intelligence (AI) model inference, according to another example. The optimization system 400 may be implemented in a low memory device, such as an edge device. In an example, the optimization system 400 may decode portions of the encoded AI model for optimally utilizing memory space of a low memory device, such as an edge device. Further, the optimization system 400 may derive inference from the decoded portion of the AI model. In addition, the optimization system 400 may delete the decoded portions of the AI model based on which inference has been derived.

The system 400 may include a processor 402, interface(s) 404, and memory 406. The processor 402 may be implemented as microprocessors, microcomputers, microcontrollers, digital signal processors, central processing units, state machines, logic circuitries, and/or other devices that manipulate signals based on operational instructions. Among other capabilities, the processor 402 may be configured to obtain an encoded AI model from another computing device, such as a server. In an example, the encoded AI model may be obtained in the form of a data file such as a metafile. The processor 402 may then extract metadata associated with the metafile. The metadata may indicate the sequence or order of layers based on which the processor 402 may initiate decoding the encoded AI model.

The interface(s) 404 may allow the connection or coupling of the optimization system 400 with one or more computing devices, such as the server through a wired network, a wireless network, or a combination of a wired and wireless network. The interface(s) 404 may also enable intercommunication between different logical as well as hardware components of the optimization system 400.

The memory 406 may be a computer-readable medium or an external memory, or internal memory, such as a flash drive, a compact disk drive, an external hard disk drive, or the like. The memory 406 may further include data which either may be utilized or generated during the operation of the optimization system 400. The memory 406 may store data that is utilized or generated by the optimization system 400, while performing a variety of functions.

In an example, the memory 406 may include a read-only memory (ROM) 408 and a random access memory (RAM) 410, each tailored to handle specific aspects of AI model data management and execution. The ROM 408 may store data file 412, image data 414, weight matrix data 416, and output data 418, and other data 420. The data file 412 may include a compressed file and metadata indicating the decoding and processing order for the model's layers. The other data 420 may, amongst other things, may serve as a repository for storing data that is processed, or received, or generated as a result of the execution of the instructions by the processor 402.

On the other hand, the RAM 410 may be utilized for on-demand loading and processing of individual layer data. As the optimization system 400 extracts and decodes a portion of the encoded model from the ROM 408, the corresponding weight matrix data 416 may be temporarily loaded into the RAM 410. The optimization system 400 may then process the weight matrix data 416 to generate layer outputs. The output generated by one weight matrix is provided as an input to the subsequent weight matrix. Accordingly, the corresponding output data 418 may be temporarily loaded into the RAM 410. Upon completion of each layer's processing, the optimization system 400 may clear the corresponding weight matrix data 416 and output data 418 from the RAM 410, freeing up space for subsequent layers. This sequential decode-process-erase cycle may enable the system to execute large AI models with minimal memory overhead, potentially allowing deployment on memory-constrained devices.

Similar to the system 100, the optimization system 400 may further include instructions 422 and engine(s) 424. In an example, the instructions 422 are fetched from the memory 406 and executed by the processor 402 included within the optimization system 400. The engine(s) 424 may include a decoding engine 426, an inference engine 428, an erasing engine 430, a validation engine 432, and other engine(s) 434. The other engine(s) 434 may further implement functionalities that supplement functions performed by the optimization system 400 or any of the engine(s) 424. The decoding engine 426, an inference engine 428, an erasing engine 430, a validation engine 432 may be implemented as a combination of hardware and programming, for example, programmable instructions to implement a variety of functionalities. In examples described herein, such combinations of hardware and programming may be implemented in several different ways. For example, the programming for the decoding engine 426, an inference engine 428, an erasing engine 430, a validation engine 432 may be executable instructions, such as instructions 422.

Such instructions 422 may be stored on a non-transitory machine-readable storage medium which may be coupled either directly with the optimization system 400 or indirectly (for example, through networked means). In an example, the decoding engine 426, an inference engine 428, an erasing engine 430, a validation engine 432 may include a processing resource, for example, either a single processor or a combination of multiple processors, to execute such instructions. In the present examples, the non-transitory machine-readable storage medium may store instructions, such as instructions 422, that when executed by the processing resource, implement the decoding engine 426, an inference engine 428, an erasing engine 430, a validation engine 432. In other examples, the decoding engine 426, an inference engine 428, an erasing engine 430, a validation engine 432 may be implemented as electronic circuitry.

In operation, the decoding engine 426 may obtain a data file, such as the data file 412, comprising the encoded AI model. The data file containing the encoded AI model may be obtained from various sources. In one implementation, the optimization system 400 may download the data file from a remote server over a network. Alternatively, the data file may be stored locally on a device, such as in non-volatile memory or on a storage drive. The data file 412 may be stored in the ROM 408 of the optimization system 400. In an example, the data file 412 may include the encoded AI model in an image format suitable for storing and transmitting structured data. The one or more images pertaining to the encoded AI model may be stored in the ROM as the image data 414. In an alternate example, the data file 412 may be in a binary file format optimized for efficient storage and retrieval of the encoded AI model. The data file 412 may use a custom format specifically designed for encoded AI models or may leverage existing file formats like HDF5 (Hierarchical Data Format version 5) which are well-suited for storing large datasets and complex data structures.

Further, the AI model may include a plurality of layers. The AI model may incorporate a wide variety of layer types and configurations to process and transform input data. For example, the AI model may be a deep neural network with multiple hidden layers between the input and output layers. The number of hidden layers in the AI model may vary depending on the application of the AI model and the complexity of the AI model. Hidden layers in the AI model may vary in number, size, and type depending on the task complexity and available computational resources. These layers may transform the input data through a series of non-linear operations, gradually extracting higher-level features and representations. Examples of the AI model may include, but are not limited to, a convolutional neural network (CNN), a recurrent neural network (RNN), a long short-term memory (LSTM) network, and a transformer model.

Upon obtaining the data file 412, the decoding engine 426 may retrieve metadata associated with the encoded AI model from the data file 412. The metadata may include information pertaining to the type of the AI model, the number of layers in the AI model, compression technique employed for encoding the AI model, sequence of the layers in the encoded version, and so on.

As mentioned above, the data file 412 may include the encoded AI model in the form of one or more images. Accordingly, based on the metadata, the decoding engine 426 may decode a portion of the encoded AI model to extract data pertaining to a first layer from the plurality of layers. For example, the decoding engine 426 may convert the one or more images into numerical weights associated with the first layer of the AI model. The numerical weights indicate a weight matrix associated with the first layer of the AI model. In an example, the decoding engine 426 may convert the one or more images into the weight matrix using the Python Imaging Library (PIL). Using the PIL, the decoding engine 426 may convert the one or more images into a numerical array. The pixel values from this numerical array may then be extracted and processed to reconstruct an original weight matrix. The extracted weight matrix may be stored in the memory 406, specifically the ROM 408 as the weight matrix data 416. In an example, the decoding engine 426 may employ a decompression technique corresponding to the compression technique used for encoding the AI model.

Upon decoding the weight matrix, the inference engine 428 may process a first input through the extracted data pertaining to the first layer to generate a first output. When the inference begins, the inference engine 428 may loads the weight matrix pertaining to the first layer into the RAM 410.

The first input processed by the inference engine 428 may vary depending on the type and purpose of the AI model. For example, the first input may be raw data, text data, sensor readings, and so on. When the inference begins, the inference engine 428 may load the weight matrix pertaining to the first layer into the RAM 410. In an example, the inference engine 428 may provide the first input to the weight matrix associated with the first layer for processing. The processing may involve matrix multiplication between the first input and weights associated with the first layer, followed by the application of an activation function. For example, if the first layer is a fully connected layer with 100 neurons, and the first input is a vector of 50 features, the processing would involve multiplying the 50-dimensional input vector by a 50×100 weight matrix. The processing may further include adding a 100-dimensional bias vector to the result of the multiplication, applying an activation function to each of the 100 resulting values. The output of the above processing is a 100-dimensional vector that would act as the first output.

The first output may be stored in the output data 418 in the ROM 408. The first output may indicate an intermediate result or feature representation derived from processing the first input through the extracted data of the first layer. This intermediate result may capture specific patterns or characteristics relevant to the AI model's task. The inference engine 428 may temporarily store metadata associated with the first output, such as dimensions or data type, to ensure proper handling of the first output in subsequent processing steps. The metadata may be used by the inference engine 428 to manage the flow of data between layers and to optimize memory usage.

As would be evident from the above, the first output may be a transformed version of the input data, such as a set of activation values or feature maps. These activation values or feature maps may represent higher-level abstractions of the input data, which can be further processed by subsequent layers of the AI model. The nature of the first output may depend on the type of layer being processed. For example, if the first layer is a convolutional layer in an image processing model, the first output may be a set of feature maps highlighting various visual elements. In a natural language processing model, the first output of the first layer may be a set of word embeddings or contextual representations.

Referring back to FIG. 4, once the first output is generated and stored in the memory 406, the erasing engine 430 may erase the weight matrix associated with the first layer of the AI model. As would be evident, the erasing engine 430 may erase the weight matrix pertaining to the first layer of the AI model from the weight matrix data 415 stored in the RAM 410. By erasing the weight matrix data for the first layer after the same has been processed, the erasing engine 430 may free up valuable memory space in the RAM 410. This allows the limited memory resources to be used more efficiently. For example, if the first layer required 0.38 MB of memory space, once the processing by the first layer is finished, that 0.38 MB is freed up and may be reused for subsequent layers or other operations.

In an example, once the memory space in the RAM 410 is freed up, the decoding engine 426 may decode another portion of the encoded AI model to extract data pertaining to a second layer from the plurality of layers. For example, the decoding engine 426 may extract a weight matrix pertaining to the second layer of the AI model. As explained above, the decoding engine 426 may obtain details pertaining to the second layer from the metadata associated with the encoded AI model. To this end, the inference engine 428 may provide the first output as a second input to the weight matrix associated with the second layer to obtain a second output. Specifically, the inference engine 428 may load the output data 418 in the RAM 410 for using the first output as an input for processing the next layer of the AI model. In some cases, the first output may also undergo additional operations before being passed to the next layer as an input. The additional operations may include normalization, activation functions, or pooling, depending on the architecture of the AI model.

This process of decoding, processing, and erasing continues for each layer of the AI model until the final output is generated. Such a sequential processing of the output may allow the optimization system 400 to build up increasingly complex representations of the input data as the input data progresses through the layers of the AI model. By processing the AI model layer-by-layer and generating intermediate outputs, the optimization system 400 may efficiently handle large and complex AI models while maintaining a small memory footprint, especially in edge devices with limited computational resources.

In an example, the validation engine 432 may calculate a mean deviation between the retrieved weight matrices and original weight matrices to determine the accuracy of the decoding process. If the mean deviation is less than a predetermined threshold, the validation engine 432 may confirm the accuracy of the retrieved weight matrices. For example, if the original weight matrix for a layer had values [0.1, 0.2, 0.3] and the retrieved weight matrix has values [0.11, 0.19, 0.31], the validation engine 432 may calculate the absolute differences (0.01, 0.01, 0.01) and then compute a mean deviation (0.01). If this mean deviation of 0.01 is below a predetermined threshold, such as 0.05, the validation engine 432 may consider the retrieved weight matrix sufficiently accurate.

In some cases, the validation engine 432 may perform the calculation for multiple layers or even the entire AI model. For instance, if a model includes 10 layers, the validation engine 432 may calculate the mean deviation for each layer and then compute an overall mean deviation across all layers. This overall mean deviation may then be compared to a threshold to determine if the entire decoded model is sufficiently accurate.

In an example, the validation engine 432 may use different metrics for different types of layers. For example, for convolutional layers, the validation engine 432 may calculate the mean deviation of the filter weights, while for fully connected layers, the validation engine 432 may calculate the mean deviation of the connection weights. In some implementations, the validation engine 432 may weigh the deviations differently based on importance of each layer or sensitivity of the AI model to changes in that layer.

If the mean deviation exceeds the predetermined threshold, the validation engine 432 may trigger a re-download or re-decoding of the affected layers. For example, if the mean deviation for a particular layer is 0.1 and the threshold is 0.05, the validation engine 432 may send a request to the decoding engine 426 to again decode that specific layer from the stored encoded AI model.

The validation performed by the validation engine 432 may ensure the accuracy and reliability of the decoded AI model. By calculating mean deviations between retrieved and original weight matrices, the validation engine 432 may detect decoding errors, maintain quality control, and optimize resource usage by identifying and re-decoding only problematic layers. Thus, the validation process helps maintain the integrity of the AI model during the decoding phase, ensuring that the decoded model accurately represents the original AI model and is ready for deployment on edge devices.

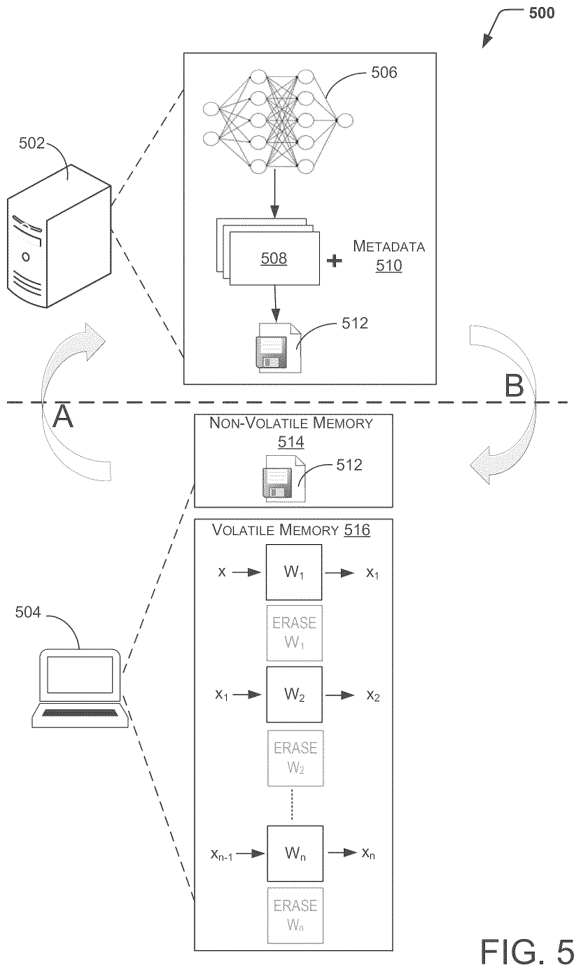

FIG. 5 illustrates an exemplary block diagram 500 depicting memory optimization in low memory devices for Artificial Intelligence (AI) model inference, according to an example. The block diagram 500 shows a process flow for encoding and decoding large AI models, such as DNNs. The block diagram 500 may be performed by an encoding system, such as the encoding system 300 implemented at a server 502 and a memory optimization system, such as the optimization system 400, implemented at a user device 504.

As depicted in FIG. 5, the server 502 may host an AI model 506. The AI model 506 may be a large AI model, such as a deep neural network (DNN) that comprises a plurality of layers. In addition, the server 502 may host the encoding system for encoding the AI model. In an example, the server 502 may be a part of distributed cloud computing environment. In another example, the server 502 may be a dedicated AI model hosting server optimized for storing and distributing encoded AI models. The server 502 may also be implemented as a cluster of servers working in tandem to handle high volumes of requests from multiple user devices. In another example, the server 502 may be a hybrid cloud solution, combining on-premises servers with public cloud resources.

Further, the encoding system may encode the AI model 506 into one or more images. In an example, the encoding system may encode the AI model upon receiving a download request from the user device 504. In another example, the encoding system may automatically encode the AI model 506 as soon as the AI model 506 is loaded on the server 502. In an example, the encoding system may encode the AI model 506 automatically when a new or updated model is uploaded to the server 502. In another example, the encoding system may encode the AI model 506 based on a predetermined schedule. For instance, the AI model 506 may be encoded during off-peak hours to optimize server resources and minimize disruption to other processes. In an example, the encoding system may encode the AI model 506 in response to detecting changes in the model's performance or structure. For example, if the AI model 506 undergoes fine-tuning or if the accuracy of the AI model 506 improves beyond a certain threshold, the encoding system may automatically initiate the encoding process.

To encode the AI model 506, the encoding system may compress the AI model into a visual representation format, such as into one or more images. In an example, each image of the one or more images may depict a weight matrix associated with a layer of the plurality of layers of the AI model 506. In another example, each weight matrix may be further divided into multiple matrices and each of the multiple matrices may be encoded into a separate image. In still another example, the encoding system may encode the entire AI model into one single image. The image format of the encoded AI model 506 may be represented as image(s) 508. In an example, the encoding system may use image libraries, such as Python Image Library (PIL) to compress the AI model 506 into one or more images.

In addition, the encoding system may embed metadata 510 pertaining to the AI model 506 with the one or more images. The metadata 510 may include details about architecture of the AI model, the image format, compression algorithm, decoding instructions having sequence of layers, and so on. The metadata 510 may be embedded by inserting the metadata into the one or more images, either within a header of an image or as part of a separate data stream, using standard metadata formats like EXIF, XMP, or custom binary formats. Accordingly, the encoding system may generate a data file 512 having the encoded and compressed AI model along with the metadata. The data file 512 may be subsequently transferred to the user device 504.

Upon receiving a request (depicted by arrow A) from the user device 504, the server 502 may share (as depicted by arrow B) the data file 512 with the user device 504. The user device 504 may be understood as any electronic device capable of processing data and executing software applications. In an example, the user device 504 may include, but is not limited to, devices such as smartphones, tablets, laptops, desktop computers, wearable devices, smart home appliances, gaming consoles, or specialized edge computing devices.

In an example, the user device 504 may have limited computational resources or memory capacity compared to server-grade hardware, necessitating efficient processing techniques for handling large AI models. The user device 504 may typically include a processor (not shown), memory (both non-volatile 514 and volatile 516), a display for output, and one or more input interfaces for user interaction or data collection. Further, the user device 504 may be capable of connecting to networks, including cellular networks, Wi-Fi, or other wireless communication protocols, enabling the user device 504 to download encoded AI models from remote servers, such as the server 502.

The data file 512 so obtained from the server 502 may be stored in the memory, such as a non-volatile memory 514 of the user device 504. The user device 504 may implement a memory optimization system that sequentially processes the encoded AI model. The memory optimization system may cause the processor to sequentially process the encoded AI model stored in the data file 512. The processor may decode a portion of the one or more images from the data file 512 to extract weight data for a first layer of the AI model. This extracted weight data may be loaded into the volatile memory 516. In an example, the decoding of the encoded AI model may be based on various decompression algorithms, depending on the specific encoding method used. Examples of certain decompression algorithms employed by the user device 504 may include, but are not limited to, JPEG decompression and PNG decompression. The specific decompression algorithm used may be indicated in the metadata accompanying the encoded AI model, allowing the user device to apply the appropriate decoding method.

As depicted in FIG. 5, a weight matrix W₁ pertaining to the first layer is loaded in the volatile memory 516 of the user device 504. Once loaded, the processor may process an input through the first layer using the extracted weight data to generate an output. Again referring to FIG. 5, an input x is processed through the weight matrix W₁ to obtain a first output x₁. Once the first output x₁ is generated and stored in the volatile memory 516, the processor may erase the weight matrix W₁ pertaining to the first layer from the volatile memory 516 to optimize memory usage of the user device 504.

Thereafter, the processor may decode another portion of the one or more images from the data file 512 to extract weight matrix W₂ for a second layer of the AI model. This extracted weight matrix W₂ may be loaded into the volatile memory 516. Once loaded, the first output x₁ generated from the first layer may be used as input for the processing of the second layer. Accordingly, the processor may provide x₁ as an input to the weight matrix W₂. The second output x₂ generated form the weight matrix W₂ may be then stored in the volatile memory 516. Once the second output x₂ is generated and stored in the volatile memory 516, the processor may erase the weight matrix W₂ pertaining to the second layer from the volatile memory 516.

The processor may repeat the above steps sequentially for each layer of the AI model until the last layer is decoded. As depicted in FIG. 5, a final weight matrix Wₙ is extracted from the one or more images. Thereafter, an output of a penultimate layer xₙ₋₁ is provided as the input to the weight matrix Wₙ which generated a final output xₙ. This sequential processing and erasing mechanism allow execution of large neural network models on devices with limited memory capacity.

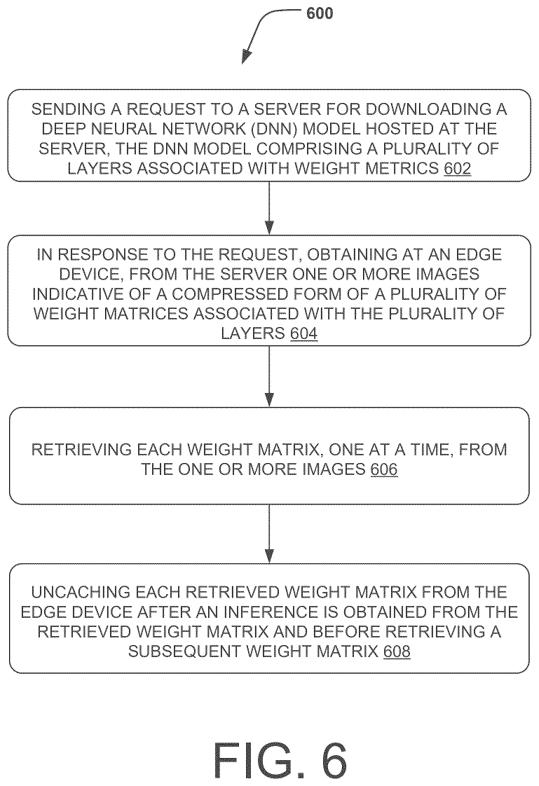

FIG. 6 illustrates example method 600 for optimizing memory in low memory devices for Artificial Intelligence (AI) model inference, according to an example. The order in which the method is described is not intended to be construed as a limitation, and any number of the described method blocks may be combined in any order to implement the methods, or an alternative method. Further, the method 600 may be implemented by processing resource or computing device(s) through any suitable hardware, non-transitory machine-readable instructions, or combination thereof.

It may also be understood that method 600 may be performed by programmed computing devices, such as the system 100 and 400, as depicted in FIGS. 1 and 4. Furthermore, the method 600 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the method 600 is described below with reference to the system 100 and 400 as described above; other suitable systems for the execution of these methods may also be utilized. Additionally, implementation of the method is not limited to such examples.

Referring to FIG. 6, at block 602, the method 600 includes sending a request to a server for downloading a deep neural network (DNN) model hosted at the server. In an example, the server hosting the DNN model may be similar to the cloud server 206 shown in FIG. 2, which may be part of a distributed cloud computing environment or a dedicated AI model hosting server. Further, the DNN model may include a plurality of layers associated with weight metrics. The DNN model hosted on the server may be a large AI model, similar to the AI model 506 described in relation to FIG. 5. The large AI model may comprise multiple interconnected layers, each associated with weight matrices that define the connections between neurons in adjacent layers.

In an example, the request may be sent from an edge device. The edge device sending the request may be a low memory device, such as one of the user devices 210 depicted in FIG. 2. Examples of the edge device may include smartphones, tablets, laptops, IoT devices, or other computing devices with limited computational resources. The request sent by the edge device may be initiated through a user interface or automatically triggered by an application running on the edge device. The request may be transmitted over the network 208 as shown in FIG. 2, which may include a wireless network, a wired network, or a combination thereof. The network may utilize various protocols such as HTTP, TCP/IP, or other suitable communication protocols.

In an example, the request may include information about the edge device's capabilities, such as available memory, processing power, or specific hardware features. This information may allow the server to optimize the DNN model or encoding thereof based on the edge device.

At block 604, the method 600 may include in response to the request, obtaining at the edge device from the server, one or more images indicative of a compressed form of a plurality of weight matrices associated with the plurality of layers. In an example, the one or more images obtained by the edge device may represent a visual encoding of the weight matrices associated with the layers of the DNN model. The compressed form of the weight matrices may significantly reduce the memory footprint of the DNN model. For instance, a weight matrix that originally required gigabytes of storage may be compressed into an image format that occupies only a fraction of that space. This compression may enable the transfer and storage of large AI models on devices with limited memory capacity.

In an example, each image may correspond to a single layer of the DNN model, while in other cases, multiple layers or even the entire model may be encoded into a single image. Upon receipt, the edge device may store the images in a non-volatile memory, such as the ROM of the edge device. In an example, the one or more images may be accompanied by metadata. The edge device may use this metadata to guide the subsequent decoding and inference processes.

At block 606, the method 600 may include retrieving each weight matrix, one at a time, from the one or more images. In an example, the decoding engine may retrieve each weight matrix from the one or more images. The decoding engine may convert portions of the one or more images back into numerical weight matrices, one layer at a time. This sequential approach to decoding enables memory optimization where only a portion of the encoded AI model is decoded at any given time.

The retrieval process may begin with the first layer of the DNN model, as indicated by the metadata associated with the encoded AI model. The decoding engine may use information from the metadata, such as the encoding scheme used and the structure of the model, to correctly interpret and extract the weight matrix data from the one or more image(s). In an example, the decoding engine may utilize image processing libraries or algorithms to convert the pixel values of the image back into numerical data. The retrieved weight matrices are loaded in a volatile memory, such as the RAM of the edge device.

In cases where a single layer's weight matrix is split across multiple image slices, the decoding engine may reconstruct the complete matrix by combining data from these multiple slices. This reconstruction process may be guided by information stored in the metadata. In addition, the timing of each weight matrix retrieval may be coordinated with the inference process, ensuring that each layer's data is available just in time for processing, and then promptly removed from memory once it's no longer needed.

At block 608, the method 600 may include uncaching each retrieved weight matrix from the edge device after an inference is obtained from the retrieved weight matrix and before retrieving a subsequent weight matrix. In an example, the erasing engine may perform the uncaching of weight matrices. Once the inference engine has processed the input through a layer and generated an output, the weight matrix for that layer is no longer needed and may be removed from the volatile memory. The uncaching process may involve clearing the specific memory addresses where the weight matrix was stored in the RAM. By loading, processing, and erasing each layer sequentially, the present subject matter may enable large model inference on memory-constrained devices, significantly expanding the range of hardware capable of running sophisticated AI models.

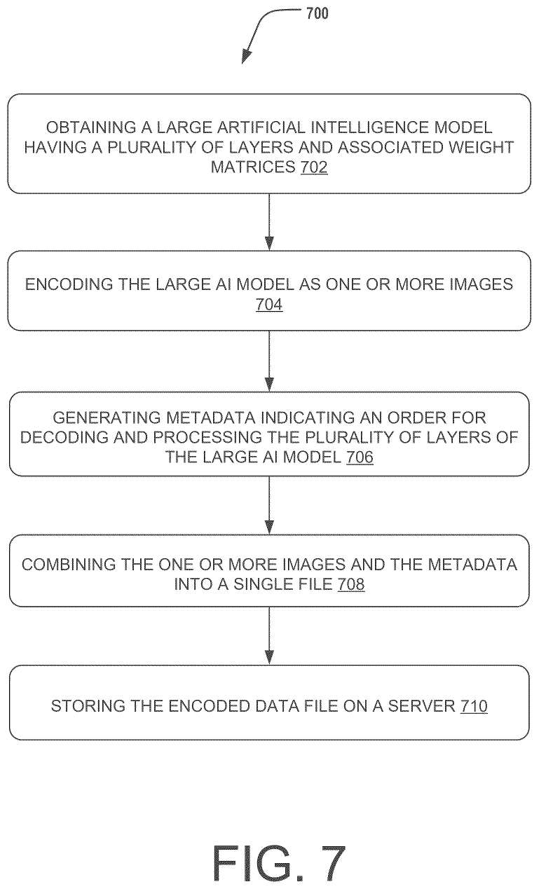

FIG. 7 illustrates a method 700 for encoding an Artificial Intelligence (AI) model for optimizing memory in low memory devices for AI model inference, according to an example. It may be understood that method 700 may be performed by programmed computing devices, such as the system 300, as depicted in FIG. 3. The present example method illustrates encoding of a large AI model. It is pertinent to note that such encoding may not occur separately and may be implemented in continuity with memory optimization without deviating from the scope of the present subject matter. In an example, the method 700 may be implemented on a server hosting a large AI model or any other computing device with memory enough to store the large AI model.

At block 702, the method 700 includes obtaining a large AI model having a plurality of layers and associated weight matrices. In an example, the large AI model may be a deep neural network (DNN) or a transformer model with multiple interconnected layers. The AI model may be obtained from a data storage system or received from an external source. In an example, the extraction engine may parse the AI model to identify its structure, including the number and types of layers, connections between layers, and associated parameters. The extraction engine may then extract information pertaining to the AI model, such as the weight matrices and bias vectors from each layer, and store this information as AI model data.

At block 704, the method 700 includes encoding the large AI model as one or more images. In an example, the encoding engine may convert the numerical values corresponding to the weight matrices into visual representations. In some cases, the entire AI model may be encoded as one image. Alternatively, each weight matrix corresponding to a layer of the AI model may be encoded into a separate image. In other aspects, each weight matrix may be divided into multiple matrices, with each sub-matrix encoded as an image slice. The encoding process may involve using image libraries such as Python Imaging Library (PIL) to transform the large weight matrices into compact image representations.

At block 706, the method 700 includes generating metadata indicating an order for decoding and processing the plurality of layers of the large AI model. The metadata may include details about the architecture of the AI model, layer ordering, number of layers, and other essential information for reconstruction. In an example, the metadata may specify the image format used, compression algorithms applied, decoding instructions with the sequence of layers, color channel mapping, and any quantization parameters used. The metadata is crucial for maintaining the structure and sequence of the model's layers during future decoding operations.

At block 708, the method 700 includes combining the one or more images and the metadata into a single file. In an example, the combining engine may create a container file that may encapsulate both the encoded images and the metadata. In some cases, the container file format may include headers or sections that clearly delineate the image data from the metadata. The combining engine may assemble the encoded components into a coherent structure that preserves the original model architecture. This may involve creating directories or nested data structures that represent the layers of the AI model, with each directory containing the relevant encoded images and layer-specific metadata.

At block 710, the method 700 includes storing the encoded data file on a server. The encoded data file, which contains the compressed AI model along with the metadata, may be saved in a centralized location for future access and deployment. The centralized storage allows for efficient distribution of the compressed AI model to various edge devices or other systems that may request it for inference or further processing. In an example, the server may be part of a distributed cloud computing environment or a dedicated AI model hosting server optimized for storing and distributing encoded AI models.

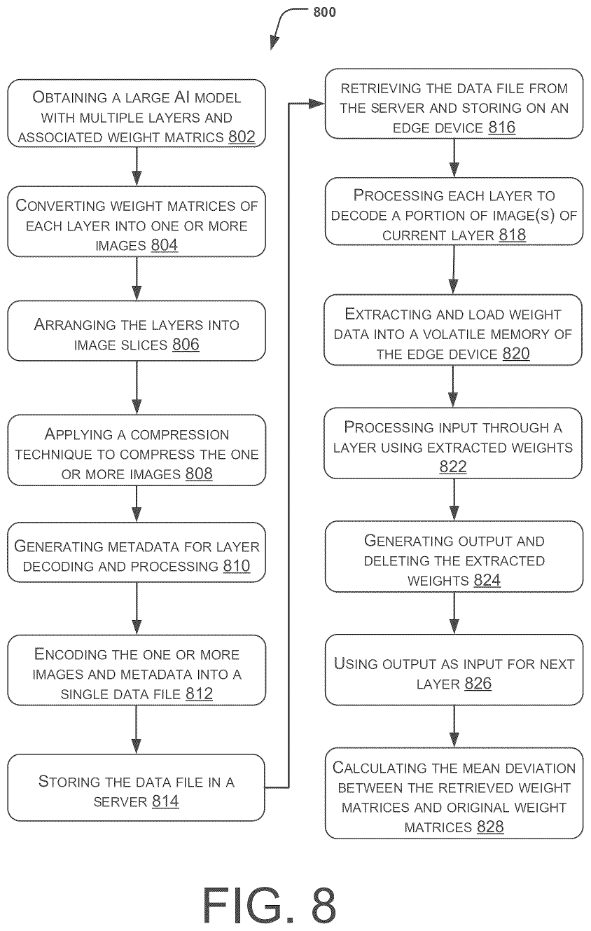

FIG. 8 illustrates example method 800 for optimizing memory in low memory devices for Artificial Intelligence (AI) model inference, according to another example. The order in which the method is described is not intended to be construed as a limitation, and any number of the described method blocks may be combined in any order to implement the methods, or an alternative method. Further, the method 800 may be implemented by processing resource or computing device(s) through any suitable hardware, non-transitory machine-readable instructions, or combination thereof. It may also be understood that method 800 may be performed by programmed computing devices, such as the systems 300 and 400, as depicted in FIGS. 3 and 4. While the method 800 is described below with reference to the systems 300 and 400 as described above; other suitable systems for the execution of these methods may also be utilized. Additionally, implementation of the method is not limited to such examples.

Referring to FIG. 8, at block 802, the method 800 includes obtaining a large AI model with multiple layers and associated weight matrices. The large AI model may be a deep neural network (DNN) or a transformer model comprising a plurality of interconnected layers. In an example, the AI model may be obtained from a data storage system or received from an external source. In an example, an encoding system may parse the AI model to identify its structure, including the number and types of layers, connections between layers, and associated parameters. The encoding system may then extract information pertaining to the AI model, such as the weight matrices and bias vectors from each layer, and store this information as AI model data.

At block 804, the method 800 includes converting the weight matrices corresponding to each layer into one or more images. In an example, the encoding system may transform the numerical values corresponding to the weight matrices into visual representations. The encoding system may use image libraries, such as Python Imaging Library (PIL) to transform the large weight matrices into compact image representations.

At block 806, the method 800 may include arranging the layers into image slices. In an example, each weight matrix may be divided into multiple matrices, with each sub-matrix encoded as an image slice. This approach may allow for more granular control over the encoding process and may facilitate efficient decoding of specific portions of the model.

At block 808, the method 800 includes applying a compression technique to compress the one or more images. In an example, the encoding system may employ various compression algorithms to compress the one or more images. Examples of the compression algorithms may include lossless compression techniques, such as Huffman coding, to preserve exact weight values of the weight matrix.

At block 810, the method 800 includes generating metadata for layer decoding and processing. The metadata may include details about the architecture of the AI model, layer ordering, number of layers, and other essential information for reconstruction. In an example, the metadata may specify the image format used, compression algorithms applied, decoding instructions with the sequence of layers, color channel mapping, and any quantization parameters used.

At block 812, the method 800 includes encoding the one or more images and the metadata into a single data file. In an example, the encoding system may create a container file to encapsulate both the encoded images and the metadata. The container file format may include headers or sections that clearly delineate the image data from the metadata. The encoding system may assemble the encoded components into a coherent structure to preserve the original model architecture.

In an example, the encoding system may encode the AI model upon receiving a download request from an edge device. In another example, the encoding system may automatically encode the AI model as soon as the AI model is loaded on the server. In an example, the encoding system may encode the AI model automatically when a new or updated model is uploaded to the server. In another example, the encoding system may encode the AI model 506 based on a predetermined schedule. For instance, the AI model may be encoded during off-peak hours to optimize server resources and minimize disruption to other processes. In an example, the encoding system may encode the AI model in response to detecting changes in the model's performance or structure. For example, if the AI model undergoes fine-tuning or if the accuracy of the AI model improves beyond a certain threshold, the encoding system may automatically initiate the encoding process.

At block 814, the method 800 includes storing the data file in a server. The encoded data file, which contains the compressed AI model along with the metadata, may be saved in a centralized location for future access and deployment. In an example, the server may be integrated into a distributed cloud infrastructure or function as a specialized platform tailored for managing and disseminating encoded AI models.

Further, at block 816, the method 800 may include retrieving the data file from the server and storing on the edge device. The edge device may be a low memory device, such as a smartphone, tablet, laptop, IoT device, or other computing device with limited computational resources. In an example, the edge device may implement a memory optimization system to retrieve the encoded AI model from the server. In an example, the data file may be transmitted over a network, which may include a wireless network, a wired network, or a combination thereof.

At block 818, the method 800 may include processing each layer to decode a portion of the one or more images pertaining to a current layer. The memory optimization may decode the portion of the one or more images to convert portions of the one or more images back into numerical weight matrices, one layer at a time. This sequential approach to decoding may enable memory optimization where only a portion of the encoded AI model is decoded at any given time.

At block 820, the method 800 may include extracting and loading weight data into a volatile memory of the edge device. As the edge device has limited memory space, the memory optimization system may extract the weight matrix associated with one layer of the AI model and load the retrieved weight matrix into a volatile memory, such as the RAM of the edge device.

At block 822, the method 800 may include processing input through a layer using extracted weights. In an example, the memory optimization system may process input data through the current layer using the extracted weight matrix.

At block 824, the method 800 may include generating output and deleting the extracted weights. In an example, once the memory optimization system has processed the input through a layer and generated an output, the weight matrix for that layer may no longer be needed and may be removed from the volatile memory. The memory optimization system may perform the uncaching of weight matrices, which may involve clearing the specific memory addresses where the weight matrix was stored in the RAM.

At block 826, the method 800 may include using the output as an input for next layer. The output generated from processing the current layer may be provided as input to the subsequent layer in the AI model. This sequential processing may allow the system to build up increasingly complex representations of the input data as it progresses through the layers of the AI model.

At block 828, the method 800 may include calculating the mean deviation between the retrieved weight matrices and original weight matrices. The memory optimization system may calculate the mean deviation to determine the accuracy of the decoding process. In an example, if the mean deviation is less than a predetermined threshold, the memory optimization system may confirm the accuracy of the retrieved weight matrices. If the mean deviation exceeds the predetermined threshold, the memory optimization system may trigger a re-download or re-decoding of the affected layers.

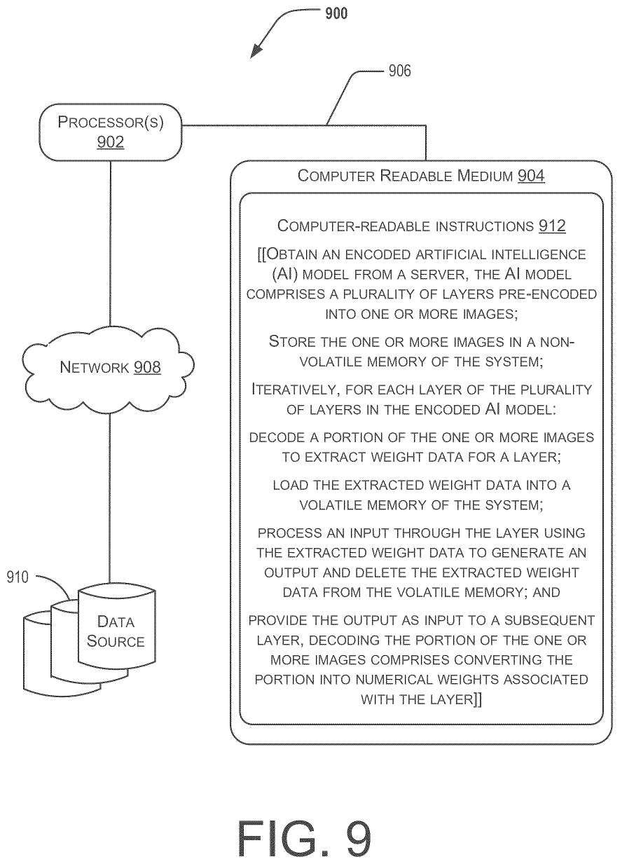

FIG. 9 illustrates a computing environment 900 implementing a non-transitory computer-readable medium for optimizing memory in low memory devices for Artificial Intelligence (AI) model inference, according to an example. In an example, the computing environment 900 includes processor(s) 902 communicatively coupled to a non-transitory computer readable medium 904 through a communication link 906. In an example implementation, the computing environment 900 may be for example, the system 100. In an example, the processor(s) 902 may have one or more processing resources for fetching and executing computer-readable instructions from the non-transitory computer readable medium 904. The processor(s) 902 and the non-transitory computer readable medium 904 may be implemented, for example, in system 100 (as has been described in conjunction with the preceding figures).

The non-transitory computer readable medium 904 may be, for example, an internal memory device or an external memory device. In an example implementation, the communication link 906 may be a network communication link. The processor(s) 902 may access the non-transitory computer readable medium 904 through a network 908. The network 908 may be a single network or a combination of multiple networks and may use a variety of communication protocols. The processor(s) 902 and the non-transitory computer readable medium 904 may also be communicatively coupled to a data source 910 over the network 908. The data source 910 may include, for example, a repository.

In an example, the non-transitory computer readable medium 904 includes a set of computer readable instructions 912 (referred to as instructions 912) which may be accessed by the processor(s) 902 through the communication link 906. Referring to FIG. 9, in an example, the non-transitory computer readable medium 904 includes instructions 912 that cause the processor(s) 902 to perform operations for optimizing memory in low memory devices for Artificial Intelligence (AI) model inference. The instructions 912 may be executed to obtain an encoded AI model from a server. The AI model may include a plurality of layers pre-encoded into one or more images. In an example, the processor 902 may obtain a data file comprising the one or more images representing the encoded AI model. The one or more images within the data file may employ different encoding schemes for different parts of the AI model. For example, convolutional layers might use one encoding method while fully connected layers use another. In another example, the one or more images may be encoded using a lossless compression algorithm.

In an example, to obtain the encoded AI model, the processor 902 may send a request to the server specifying the desired AI model. The request may include parameters such as model version, target device specifications, or specific configuration options. The data file may include the one or more images and metadata. The metadata may provide information about the encoding scheme, layer structure, and instructions for decoding and using the model. The metadata may also indicate an order for decoding and processing the plurality of layers.

Upon obtaining the encoded AI model, the instructions 912 may cause the processor(s) 902 to store the one or more images in a non-volatile memory of the system. The non-volatile memory may be a flash drive, an SD card, or internal storage of a mobile device. In an example, the encoded AI model may be received by an edge device or a user device from a cloud server via the network 908. Accordingly, a memory optimization system implemented on the user device may handle the storage of the received encoded AI model.

Once stored, the instructions 912 may cause the processor(s) 902 to perform operation iteratively, for each layer of the plurality of layers in the encoded AI model. In an example, the operations may include decoding a portion of the one or more images to extract weight data for a layer. The decoding the portion of the one or more images may include converting the portion into numerical weights associated with the layer. In an example, he decoding may include using image processing libraries or algorithms to convert the pixel values of the encoded images back into numerical data representing the weight matrices. The metadata included in the data file may provide information on how to interpret and decode each portion of the images corresponding to different layers. The decoding may include various techniques depending on the encoding method used. For instance, if frequency-domain transformations were used in encoding, inverse transformations may be applied during decoding.

Additionally, the instructions 912 may cause the processor(s) 902 to perform the operation of loading the extracted weight data into a volatile memory of the system. The decoded numerical weights may be temporarily stored in the volatile memory for immediate use in processing inputs through the corresponding layer. For example, the processor 902 may store the encoded AI model, represented as one or more images, in non-volatile memory such as a ROM. When processing the encoded AI model, the processor 902 may decode only a portion of the one or more images at a time, corresponding to a single layer of the model.

In an example, as the processor 902 may extract a portion of the encoded AI model from the ROM, the processor 902 may convert the image-based representation back into numerical weight data associated with the current layer. This extracted weight data is then loaded into the volatile memory (such as RAM) of the system. By loading only, the weight data for the current layer into the volatile memory, the memory usage optimization.

The instructions 912 may also cause the processor(s) 902 to process an input through the layer using the extracted weight data to generate an output and delete the extracted weight data from the volatile memory. Processing of the input through the layer may include matrix multiplication between the input and the weight matrix associated with the layer. Further, activation functions may be applied to the outcome of the multiplication. The processing of the input may generate an output, which may serve as an intermediate representation for the AI model's task. After generating the output for the current layer, the processor 902 may remove the weight data associated with that layer from the volatile memory. As a result, memory usage of the system may be optimized, especially on devices with limited resources. By erasing the weight data that is no longer needed, the system frees up memory space in the RAM.

In an example, the instructions 912 may cause the processor(s) 902 to provide the output as an input to a subsequent layer. As each layer is decoded from the ROM and processed, the output of one layer may become the input for the subsequent layer. This process continues layer by layer until the final output of the AI model is produced. By passing the intermediate outputs between layers in this manner, the system can efficiently process the entire model without needing to store all layer data in memory simultaneously.

In an example, the instructions 912 may cause the processor(s) 902 to calculate a mean deviation between the extracted weight data and original weight data. If the mean deviation is less than a predetermined threshold, the processor(s) 902 may confirm the accuracy of the retrieved weight matrices. In an example, a layer of the DNN model may have a weight matrix of 1000 elements. The original weight data for the layer may be encoded into an image and stored on the server. After retrieving and decoding the image on the edge device, the weight data is extracted.

Once extracted, the processor 902 may calculate the mean deviation between the extracted weights and the original weights. To calculate the mean deviation, the processor 902 may subtract each extracted weight value from a corresponding original weight value. Thereafter, the processor 902 may take absolute value of these differences. Based on the absolute differences, the processor 902 may calculate a mean deviation. Considering that the calculated mean deviation is 0.0015. Further, the system may have a predetermined threshold, for example, 0.005. Since the calculated mean deviation (0.0015) is less than the threshold (0.005), the processor 902 may confirm that the retrieved weight matrices are sufficiently accurate.

Accordingly, the present subject matter may enable the execution of sophisticated AI models on a variety of devices with constrained memory resources. By loading, processing, and removing each layer's data in sequence, complex models that would otherwise exceed the device's memory capacity if loaded entirely may be implemented on constrained memory devices. Such sequential processing and efficient memory utilization may allow deployment of advanced AI models across a broad spectrum of hardware, including devices with limited computational capabilities.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
a processor;
a memory; and
a machine-readable storage medium comprising instructions executable by the processor to:
obtain a data file comprising an encoded artificial intelligence (AI) model, wherein the AI model includes a plurality of layers;
decode a portion of the encoded AI model to extract data pertaining to a first layer from the plurality of layers, wherein the extracted data is stored in the memory;
process a first input through the extracted data pertaining to the first layer to generate a first output;
decode another portion of the encoded AI model to extract data pertaining to a second layer from the plurality of layers, wherein the first output is provided as a second input to the second layer to obtain a second output; and
upon generating the first output, erase the data pertaining to the first layer from the memory for memory optimization.

2. The system as claimed in claim 1, wherein the AI model is a large language model.

3. The system as claimed in claim 1, wherein the data file stores the encoded AI model as one or more images.

4. The system as claimed in claim 3, wherein to decode the AI model the processor is to convert the one or more images into numerical weights associated with each layer of the plurality of layers.

5. The system as claimed in claim 3, wherein the memory comprises a random access memory (RAM) and a read-only memory (ROM), and wherein the one or more images corresponding to the encoded AI model are stored in the ROM.

6. The system as claimed in claim 5, wherein the processor is to load the extracted data pertaining to each layer of the plurality of layers into the RAM for processing.

7. The system as claimed in claim 1, wherein the system is a low memory device.

8. The system as claimed in claim 1, wherein the AI model is encoded using a lossless compression algorithm.

9. The system as claimed in claim 1, wherein the data file comprises metadata indicating an order for decoding and processing the plurality of layers of the encoded AI model.

10. A method comprising:
sending a request to a server for downloading a deep neural network (DNN) model hosted at the server, the DNN model comprising a plurality of layers associated with weight matrices;
in response to the request, obtaining at an edge device, from the server, one or more images indicative of a compressed form of a plurality of weight matrices associated with the plurality of layers;
retrieving each weight matrix, one at a time, from the one or more images; and
uncaching each retrieved weight matrix from the edge device after an inference is obtained from the retrieved weight matrix and before retrieving a subsequent weight matrix.

11. The method as claimed in claim 10, wherein retrieving each weight matrix comprises:
applying a decompression algorithm specific to the image format used for compression of the plurality of weight matrices.

12. The method as claimed in claim 10, the method further comprising:
calculating a mean deviation between each of the retrieved weight matrix and original weight matrix; and
determining accuracy of each of the retrieved weight matrix when the mean deviation is less than a predetermined threshold.

13. The method as claimed in claim 10, wherein the one or more images comprise a series of image slices, and wherein each slice corresponds to a portion of a layer of the plurality of layers.

14. The method as claimed in claim 10, the method further comprising:
determining a memory capacity of the edge device; and
selectively retrieving portions of the one or more images based on the determined memory capacity.

15. The method as claimed in claim 10, wherein obtaining the one or more images at the edge device comprises storing the one or more images in a read-only memory (ROM) of the edge device.

16. The method as claimed in claim 10, wherein retrieving each weight matrix comprises loading the retrieved weight matrix into a random access memory (RAM) of the edge device.

17. A non-transitory computer-readable medium comprising instructions, the instructions being executable by a processing resource of a system, to:
obtain an encoded artificial intelligence (AI) model from a server, wherein the AI model comprises a plurality of layers pre-encoded into one or more images;
store the one or more images in a non-volatile memory (NVM) of the system;
iteratively, for each layer of the plurality of layers in the encoded AI model:
decode a portion of the one or more images to extract weight data for a layer;
load the extracted weight data into a volatile memory of the system;
process an input through the layer using the extracted weight data to generate an output and delete the extracted weight data from the volatile memory; and
provide the output as input for a subsequent layer, wherein decoding the portion of the one or more images comprises converting the portion into numerical weights associated with the layer.

18. The non-transitory computer-readable medium as claimed in claim 17, wherein the encoded AI model comprises metadata indicating an order for decoding and processing the plurality of layers.

19. The non-transitory computer-readable medium as claimed in claim 17, wherein the instructions, when executed by the processing resource, cause the processing resource to:
calculate a mean deviation between the extracted weight data and original weight data; and
determine accuracy of the extracted weight data when the mean deviation is less than a predetermined threshold.

20. The non-transitory machine-readable medium as claimed in claim 17, wherein the one or more images are encoded using a lossless compression algorithm.
